(19) United States
(12) Patent Application Publication
(10) Pub. No.: US 2022/0407981 A1
(43) Pub. Date: Dec. 22, 2022

(54) IMAGE OUTPUT DEVICE, IMAGE OUTPUT SYSTEM, AND IMAGE OUTPUTTING METHOD

(71) Applicant: SHARP KABUSHIKI KAISHA, Osaka (JP)

(72) Inventor: TAKASHI USUI, Osaka (JP)

(21) Appl. No.: 17/839,409

(22) Filed: Jun. 13, 2022

(30) Foreign Application Priority Data
Jun. 22, 2021 (JP) 2021-103464

(51) Int. Cl. H04N 1/32; H04N 1/44; H04N 1/00

(52) U.S. Cl. CPC H04N 1/32267; H04N 1/4426; H04N 1/444; H04N 1/00127; H04N 1/32309; H04N 2201/3269

(57) ABSTRACT

An image output device, includes a controller and an image outputter. The controller, when a specific area that matches a specific condition is present in a first image, stores, in a storing area, information that is based on the specific area, generates an identification code that includes access information for accessing the stored information that is based on the specific area, and outputs a second image where the specific area of the first image is replaced with an image that includes the identification code.

### CROSS-REFERENCE TO RELATED APPLICATION

The present application claims priority from Japanese Patent Application Number 2021-103464, the content to which is hereby incorporated by reference into this application.

### BACKGROUND OF THE INVENTION

### 1. Field of the Invention

The present disclosure relates to an image output device and the like.

### 2. Description of the Related Art

So as to prevent a leakage of any confidential information which a user does not want to be known to any unspecified other person and so as to reduce the cost required for such prevention, Japanese Unexamined Patent Application Publication No. 2009-177699 discloses a technology that, for any image information including input secret information, codes the secret information, and replaces the image information with coded secret information.

### SUMMARY OF THE INVENTION

The technology described in the Japanese Unexamined Patent Application Publication No. 2009-177699 replaces the image information's to-be-kept-secret portion with the coded secret information, and executes a printing based on the replaced image information generated after the replacing.

In the technology described in the Japanese Unexamined Patent Application Publication No. 2009-177699, a decoder for decoding the coded secret information for each viewer environment is required for visualization of the coded secret information. Once the information or the like necessary for the decoding is acquired, the replaced image information can be decoded anytime and anywhere. Therefore, if the replaced image information is diffused together with the information necessary for the decoding, viewing by any unspecified other person could not be restricted.

In addition, the technology described in the Japanese Unexamined Patent Application Publication No. 2009-177699 is designed to reduce the cost for preventing a secret leakage by replacing the image information's to-be-kept-secret portion with the coded secret information. However, the coded secret information according to the Japanese Unexamined Patent Application Publication No. 2009-177699 does not necessarily reduce the color material consumption amount, the drawing area, or the like, and, as the case may be, causes such a problem that the increase in the amount of to-be-added information increases the color material consumption amount and the drawing area.

It is an object of the present disclosure to provide an image output device and the like that, in the case where a to-be-drawn image includes a to-be-managed image area, can facilitate the management of the image area, and can reduce any cost for the image formation in the image area or in the overall drawing area.

For solving the above problem, an image output device according to the present disclosure includes: a controller; and an image outputter, wherein the controller, when a specific area that matches a specific condition is present in a first image, stores, in a storing area, information that is based on the specific area, generates an identification code that includes access information for accessing the stored information that is based on the specific area, and outputs a second image where the specific area of the first image is replaced with an image that includes the identification code.

In addition, an image output system according to the present disclosure includes: an image output device having a controller and an image outputter; and a storage device having a storage and an outputter, wherein the controller, when a specific area that matches a specific condition is present in a first image, has the storage store information that is based on the specific area, generates an identification code that includes access information for accessing the stored information that is based on the specific area, and outputs a second image where the specific area of the first image is replaced with an image that includes the identification code, and wherein the outputter, according to an access that is based on the identification code, outputs the image included in the stored specific area.

In addition, an image outputting method according to the present disclosure includes: when a specific area that matches a specific condition is present in a first image, storing, in a storing area, information that is based on the specific area; generating an identification code that includes access information for accessing the stored information that is based on the specific area; and outputting a second image where the specific area of the first image is replaced with an image that includes the identification code.

According to the present disclosure, it is possible to provide an image output device and the like that, in the case where a to-be-drawn image includes a to-be-managed image area, can facilitate the management of the image area, and can reduce any cost for the image formation in the image area or in the overall drawing area.

### BRIEF DESCRIPTION OF THE DRAWINGS

FIG. 1 is a diagram describing an overall configuration according to a first embodiment.

FIG. 2 is a diagram describing the functional configuration of a multifunction peripheral according to the first embodiment.

FIG. 3 is a diagram describing the functional configuration of a storage according to the first embodiment.

FIG. 4 is a diagram describing the functional configuration of a terminal device according to the first embodiment.

FIG. 5 is a sequence diagram describing the flow of processes according to the first embodiment.

FIG. 6 is a flowchart describing the flow of processes of the multifunction peripheral according to the first embodiment.

FIG. 7 is a flowchart describing the flow of processes of the storage according to the first embodiment.

FIG. 8 is a diagram describing an example of a data configuration of an identification code correspondence table.

FIG. 9 is a flowchart describing the flow of processes of the terminal device according to the first embodiment.

FIGS. 10A and 10B are a diagram describing an operation example of the first embodiment.

FIG. 11 is a diagram describing the operation example of the first embodiment.

FIG. 12 is a diagram describing the functional configuration of a multifunction peripheral according to a second embodiment.

FIGS. 13A to 13C are a diagram describing an operation example of the second embodiment.

FIG. 14 is a diagram describing the functional configuration of a multifunction peripheral according to a third embodiment.

FIGS. 15A and 15B are a diagram describing an operation example of the third embodiment.

FIG. 16 is a diagram describing the functional configuration of a multifunction peripheral according a fourth embodiment.

FIGS. 17A and 17B are a diagram describing an operation example of the fourth embodiment.

FIG. 18 is a diagram describing the functional configuration of a multifunction peripheral of a fifth embodiment.

FIGS. 19A and 19B are a diagram describing an operation example of the fifth embodiment.

### DETAILED DESCRIPTION OF THE INVENTION

Embodiments of the present disclosure will be described below with reference to the drawings. In the present disclosure, a multifunction peripheral that can realize, in a single housing, multiple functions such as copying, image sending, faxing, and data saving is described as an aspect of an image output device or image forming device. The following embodiments are each an example to describe the present disclosure, and the technical scope of the description in the claims is not limited to the following description.

### 1. First Embodiment

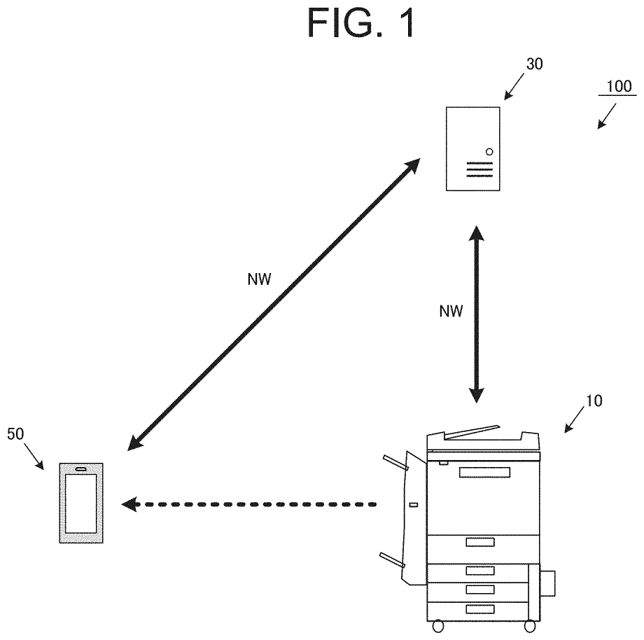

FIG. 1 is a diagram describing an overall configuration according to a first embodiment of an image output system 100. The image output system 100 includes a multifunction peripheral 10, an external storage device 30, a terminal device 50.

The multifunction peripheral 10 is communicatively connected to the external storage device 30 via a network NW shown by a solid line in the figure. The terminal device 50 is also communicatively connected to the external storage device 30 via the network NW. The terminal device 50 is configured so as to be able to acquire a second image (described below) from the multifunction peripheral 10 (dotted line in the figure).

1.1 Functional Configuration

1.1.1 Regarding Multifunction Peripheral 10

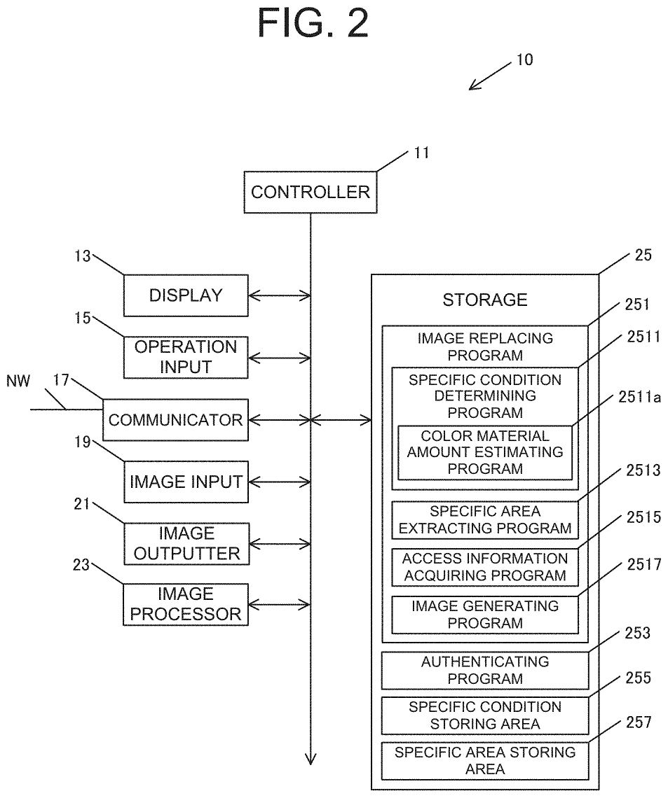

FIG. 2 is a diagram describing the functional configuration of the multifunction peripheral 10. The multifunction peripheral 10 includes a controller 11, a display 13, an operation input 15, a communicator 17, an image input 19, an image outputter 21, an image processor 23, and a storage 25.

The controller 11 controls the entirety of the multifunction peripheral 10. The controller 11 can include, for example, one or more arithmetic devices (CPU (Central processing unit), and the like). The controller 11 reads out and executes various programs stored in the storage 25 thereby to realize the function of the controller 11.

The display 13 displays various pieces of information to a user and the like. The display 13 can include, for example, an LCD (Liquid crystal display), an organic EL (Electro-luminescence) display, and the like.

The operation input 15 accepts the inputting of the information by the user and the like. The operation input 15 can include a hard key (e.g., numeric keypad), a button, and the like. The operation input 15 can be configured as a touch screen that allows inputting via the display 13. In this case, the touch screen inputting methods that can be adopted includes, for example, resistive, infrared, electromagnetic induction, and capacitive methods.

The communicator 17 includes either wired/wireless interface or both interfaces for communication with the other devices such as the external storage device 30 and the terminal device 50 via the network (NW) such as LAN (Local area network), WAN (Wide area network), the Internet, telephone line, fax line, and the like.

The image input 19 accepts input of document printout or document data. When accepting the inputting of the document printout, the image input 19 scans and reads the document printout with an image sensor such as CCD (Charge coupled device) and CIS (Contact image sensor), thereby making it possible to configure the image input 19 as a scanner for generating image information. In addition, for inputting the document data, the image input 19 can include connection ports of various devices such as USB (Universal serial bus) and eSATA (external serial ATA), card readers for various memory cards such as SD card, and an interface for proximity (near field) wireless communication. The communicator 17, which communicates with any other device via the network NW and inputs the document data, can be used as the image input 19.

The image outputter 21 outputs the document printout and the document data. When outputting an image as the document printout, the image outputter 21 can be configured as an image former that forms, on paper as a print medium, the image that is based on the image information. The image former can include, for example, a laser printer using an electrophotographic method, in which case the image former forms the image by using toner as a color material. In addition, for outputting the document data, the image outputter 21 can include connection ports of various devices such as USB and eSATA, card readers for various memory cards such as SD card, and an interface for proximity (near field) wireless communication. The communicator 17, which communicates with any other device via the network NW and outputs the document data, can be used as the image outputter 21.

The image processor 23 includes one or more arithmetic devices (GPU (graphics processor) and the like). The image processor 23 reads out and executes various programs related to the image process stored in the storage 25, thereby to realize the function of the image processor 23. The function read out and executed by the image processor 23 can also be read out and executed by the controller 11.

The storage 25 stores various programs and various data necessary for the operation of the multifunction peripheral 10. The storage 25 can include storages such as RAM (Random access memory), HDD (Hard disk drive), SSD (Solid state drive), and ROM (Read only memory).

In the first embodiment, the storage 25 stores an image replacing program 251 and an authenticating program 253, and secures a specific condition storing area 255 and a specific area storing area 257.

The image replacing program 251 is read out by the image processor 23 when executing an image replacing process on the input document printout or document data. The image replacing program 251 includes a specific condition determining program 2511, a specific area extracting program 2513, an access information acquiring program 2515, and an image generating program 2517.

The specific condition determining program 2511 is read out by the image processor 23 when determining whether or not a specific area matching a specific condition is present in the image included in the document printout or document data (hereinafter, as the case may be, referred to as first image). In the first embodiment, when a toner saving mode or a paper saving mode, which reduces the consumption of the toner as the color material, is selected for printing or copying, the case of the color material consumption amount being large is defined as the specific condition, and the image area matching the specific condition is defined as the specific area. The specific condition, including a specific color material consumption amount's threshold (predetermined amount), is stored in the specific condition storing area 255.

A color material amount estimating program 2511a is read out by the image processor 23 when estimating the color material amount consumed for printing out each image area included in the first image. The image processor 23 having read out the specific condition determining program 2511 compares the estimated color material consumption amount with the color material consumption amount's threshold as the specific condition read out from the specific condition storing area 255, thereby to determine whether or not the specific area matching the specific condition is present in the first image.

The specific area specific area extracting program 2513 is read out by the image processor 23 when determining that the specific area matching the specific condition is present. The image processor 23 having read out the specific area extracting program 2513 extracts the specific area from the first image. In the present disclosure, the specific area is synonymous with an image area (information) that satisfies the specific condition.

The access information acquiring program 2515 is read out by the image processor 23 when the specific area is extracted from the first image. The image processor 23 having read out the access information acquiring program 2515 sends the extracted specific area to the external storage device 30, and sends a request for acquiring access information generated by the external storage device 30. In addition, the access information is for accessing the image information related to the specific area stored by the external storage device 30. The access information is not particularly limited, examples thereof including: a predetermined character string, and an identification code (code data) that images the access information such as two-dimensional code such as QR code (registered trademark) and Data Matrix, and one-dimensional barcode such as GS1, UPC, EAN and Code 128. The access information may be acquired, as an identification code, from the external storage device 30, or the access information acquired from the external storage device 30 by the image processor 23 having read out the access information acquiring program 2515 may be converted into the predetermined character string or the identification code. In the following description, an aspect of acquiring the identification code generated by imaging the access information in the external storage device 30 will be described.

The image generating program 2517 is read out by the image processor 23 when acquiring the identification code from the external storage device 30. In the first image, the image processor 23 having read out the image generating program 2517 replaces the image area, which corresponds to the specific area, with the identification code acquired from the external storage device 30, thereby to generate the second image. In addition, the generated second image as the document printout or document data is output from the image outputter 21, and is supplied to the terminal device 50, the user, and the like.

The authenticating program 253 is read out by the controller 11 when authenticating the external storage device 30 or the terminal device 50. The controller 11 having read out the authenticating program 253 uses the authentication information such as user ID, authentication password, and device identification ID which are not shown, and thereby authenticates the external storage device 30 or the terminal device 50.

The specific condition storing area 255 stores the specific condition including the color material consumption amount's threshold.

The specific area storing area 257 stores the specific area extracted by the image processor 23 having read out the specific area extracting program 2513. In addition, the specific area storing area 257 can be used as an internal storage to store image area same as the specific area sent to the external storage device 30.

1.1.2 Regarding External Storage Device 30

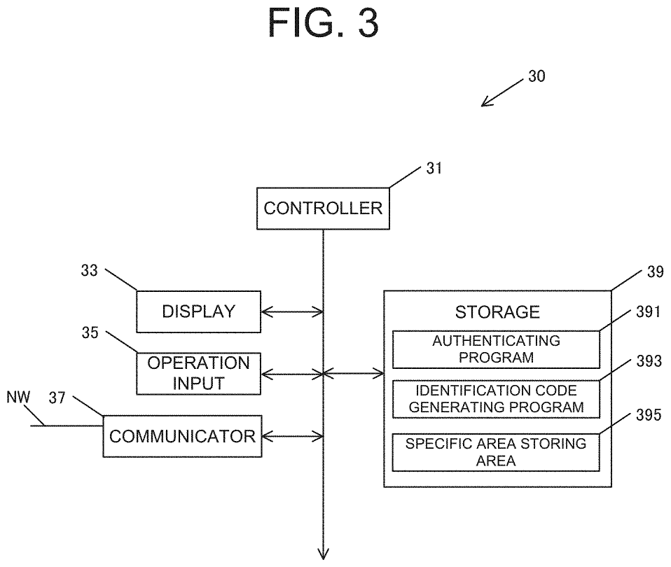

FIG. 3 is a diagram describing the functional configuration of the external storage device 30. If having a configuration that can store the specific area sent from the multifunction peripheral 10 via the network NW and can generate, in response to the request from the multifunction peripheral 10, the access information for accessing the specific area, the external storage device 30 according to the present disclosure is not limited in terms of an aspect thereof, and a server, NAS (Network attached storage), cloud computing, or the like can be used. In addition, the function of the external storage device 30 described below may be the aspect provided in the multifunction peripheral 10.

The external storage device 30 includes a controller 31, a display 33, an operation input 35, a communicator 37, and a storage 39.

The controller 31 controls the entirety of the external storage device 30. The controller 31 can include one or more arithmetic devices (CPU, etc.), for example. The controller 31 reads out and executes various programs stored in the storage 39 thereby to realize the function of the controller 31.

The display 33 displays various pieces of information to the user and the like. The display 33 can include, for example, the LCD, the organic EL display, and the like.

The operation input 35 accepts the inputting of the information from the user and the like. For the operation input 35, various inputting measures such as keyboard and mouse, for example, can be used.

The communicator 37 includes either wired/wireless interface or both interfaces for communication with the other devices such as the multifunction peripheral 10 and the terminal device 50 via the LAN, the WAN, the Internet, the telephone line, and the like.

The storage 39 stores various programs and various data necessary for the operation of the external storage device 30. The storage 39 include storages such as RAM, HDD, SSD, and ROM.

In the first embodiment, the storage 39 stores an authenticating program 391 and an identification code generating program 393, and secures a specific area storing area 395.

The authenticating program 391 is read out by the controller 31 when authenticating the multifunction peripheral 10 or the terminal device 50. The controller 31 having read out the authenticating program 391 uses the authentication information such as the user ID, the authentication password, and the device identification ID which are not shown, and thereby authenticates the multifunction peripheral 10 or the terminal device 50.

In response to the access information acquiring request from the multifunction peripheral 10, the identification code generating program 393 is read out by the controller 31 when generating the access information. The controller 31 having read out the identification code generating program 393 images the access information including a URL (Uniform resource locator), a host name, or an IP address to access the specific area stored in the specific area storing area 395, thereby to generate the identification code. In addition, the controller 31 converts the to-be-generated identification code into a size smaller than an image size of the specific area.

The specific area storing area 395 stores the specific area acquired from the multifunction peripheral 10.

1.1.3 Regarding Terminal Device 50

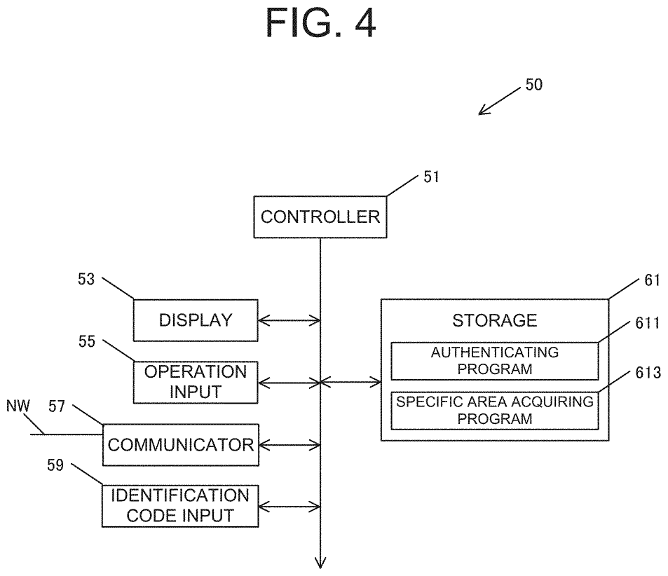

FIG. 4 is a diagram describing the functional configuration of the terminal device 50. The terminal device 50 according to the present disclosure is assumed to be, for example, a terminal device such as smartphone, tablet, cellular phone, and laptop computer, but is not particularly limited provided that the terminal device 50 should be the one that includes at least a function to input the identification code and a function for communication.

The terminal device 50 includes a controller 51, a display 53, an operation input 55, a communicator 57, an identification code input 59, and a storage 61.

The controller 51 controls the entirety of the terminal device 50. The controller 51 can include one or more arithmetic devices (CPU, etc.), for example. The controller 51 reads out and executes various programs stored in the storage 61 thereby to realize the function of the controller 51.

The display 53 displays various pieces of information to user and the like. The display 53 can include, for example, the LCD, the organic EL display, and the like.

The operation input 55 accepts the inputting of the information from the user and the like. The operation input 55 can be configured as a touch screen that allows inputting via the display 53.

The communicator 57 includes either wired/wireless interface or both interfaces for communication with the other device such as the multifunction peripheral 10 and the external storage device 30 via the LAN, the WAN, the Internet, the telephone line, and the like.

The identification code input 59 includes shooting means such as camera, thereby to input the identification code as the image information.

The storage 61 stores various programs and various data necessary for the operation of the terminal device 50. The storage 61 include a storage such as RAM, HDD, SSD, and ROM.

In the first embodiment, the storage 61 stores an authenticating program 611 and a specific area acquiring program 613.

The authenticating program 611 is read out by the controller 51 when authenticating the multifunction peripheral 10 or the external storage device 30. The controller 51 having read out the authenticating program 611 uses the authentication information such as the user ID, the authentication password, and the device identification ID which are not shown, and thereby authenticates the multifunction peripheral 10 or the external storage device 30.

The specific area acquiring program 613 is read out by the controller 51 when acquiring the identification code from the second image generated by the multifunction peripheral 10 and, acquiring the specific area stored in the external storage device 30 based on the identification code. The controller 51 having read out the specific area acquiring program 613 controls the identification code input 59 thereby to acquire the identification code from the second image. Then, the controller 51 accesses the external storage device 30 based on the access information included in the identification code, thereby to access the specific area stored in the specific area storing area 395.

Flow of Processes

1.2.1 Overall Process

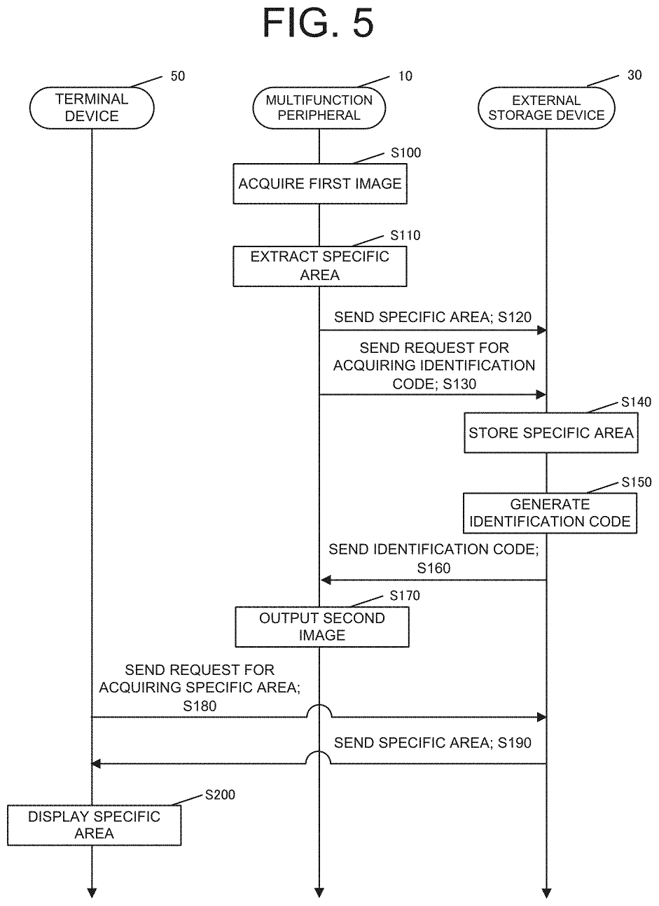

Then, the overall process according to the first embodiment will be described using the sequence diagram in FIG. 5. In addition, the following description will be made based on an assumption that the multifunction peripheral 10, the external storage device 30, and the terminal device 50, by executing the authenticating program stored in the respective devices, are in a state of being authenticated with each other.

First, the multifunction peripheral 10 controls the image input 19 thereby to accept the inputting of the document printout or document data and acquire the first image (step S100).

Then, the image processor 23 of the multifunction peripheral 10 reads out the image replacing program 251. When the first image includes the specific area, the image processor 23 extracts the specific area (step S110).

The image processor 23 sends the specific area to the external storage device 30 (step S120). Then, to the external storage device 30, the image processor 23 sends an identification code acquiring request as the access information (step S130).

The external storage device 30 stores the received specific area in the specific area storing area 395 (step S140). Then, the controller 31 of the external storage device 30 reads out the identification code generating program 393 thereby to generate the identification code that is based on the specific area (step S150).

The controller 31 sends the generated identification code to the multifunction peripheral 10 (step S160).

The image processor 23 of the multifunction peripheral 10 having received the identification code reads out the image generating program 2517 thereby to, in the first image, replace the image area, which corresponds to the specific area, with the received identification code, thereby to generate the second image. Then, the image processor 23 outputs the generated second image via the image outputter 21 (step S170).

When the second image is output from the multifunction peripheral 10, the controller 51 of the terminal device 50 reads out the specific area acquiring program 613. The controller 51 having read out the specific area acquiring program 613 controls the identification code input 59 thereby to acquire the identification code from the second image.

Based on the access information included in the identification code, the controller 51 sends a specific area acquiring request to the external storage device 30 (step S180).

The controller 31 of the external storage device 30 having received the specific area acquiring request reads out the specific area from the specific area storing area 395, and send the specific area to the terminal device 50 (step S190).

The controller 51 of the terminal device 50 having received the specific area from the external storage device 30 displays the received specific area on the display 53 (step S200).

1.2.2 Regarding Process of Multifunction Peripheral 10

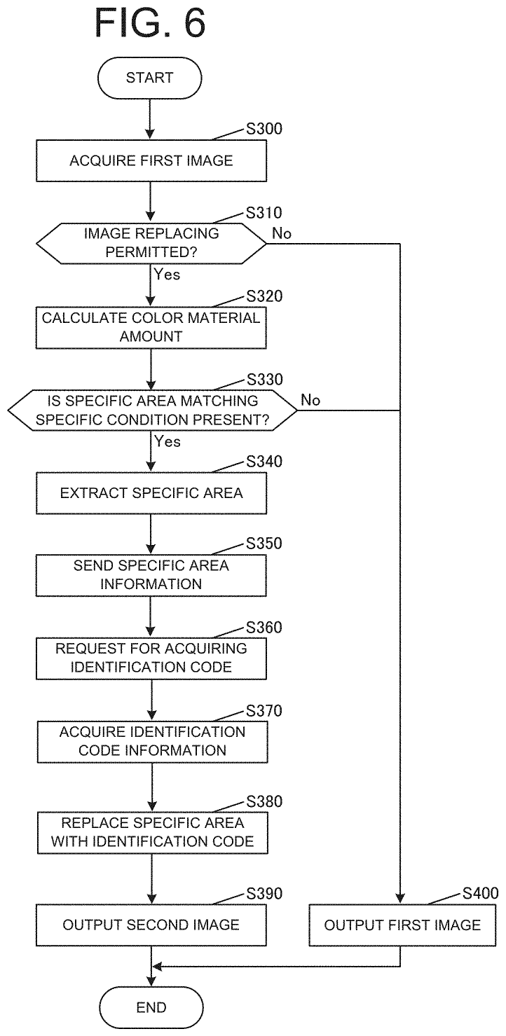

Then, the process of the multifunction peripheral 10 will be described using the flowchart in FIG. 6. First, the multifunction peripheral 10 controls the image input 19 thereby to accept the inputting of the document printout or document data and to acquire the first image (step S300).

The image processor 23 of the multifunction peripheral 10 determines whether or not the image replacing is permitted (step S310). In this case, referring to the system setting, etc., for example, and if an item related to the image replacing is set to “allowable”, the image processor 23 can determine that the image replacing is permitted. When the first image is acquired, a user interface (not shown) to inquire the user whether or not to permit the image replacing may be displayed on the display 13. When the user permits the image replacing, the image processor 23 proceeds to the next step.

When it is determined that the image replacing is permitted, the image processor 23 reads out the image replacing program 251. Then, the image processor 23 having read out the color material amount estimating program 2511a included in the image replacing program 251 estimates the color material consumption amount that is consumed when each image area included in the first image is printed out (step S310; Yes→step S320).

By the way, the color material consumption amount can be estimated depending on (1) in the case of printing (2) or in the case of copying/scanning.

For example, (1) in the case of printing, a page description language output from a printer driver describes text (character), vector (vector data such as line and figure), and raster (image data such as photograph) separately. In principle, the image processor 23, by executing the rasterization and color conversion on an object other than the text, can estimate the color material consumption amount.

(2) When the paper document is read by the image input 19 (scanner), as in the case of copying/scanning, there is no distinction such as text/vector/raster. However, the image processor 23 separates the area into a character area, a photograph area, etc., and executes an image process that is appropriate for each; therefore, it is possible to estimate, in the same way as for prints, the color material consumption amount for each area acquired after the separating of the area.

The image processor 23 having read out the specific condition determining program 2511 compares the color material consumption amount estimated in step S320 with the color material consumption amount's threshold as the specific condition read out from the specific condition storing area 255, thereby to determine whether or not the specific area matching the specific condition is present in the first image (step S330).

When it is determined that the specific area matching the specific condition is present, the image processor 23 reads out the specific area extracting program 2513. The image processor 23 having read out the specific area extracting program 2513 extracts a corresponding specific area from the first image (step S330; Yes→step S340).

Extracting the specific area from the first image, the image processor 23 reads out the access information acquiring program 2515. The image processor 23 having read out the access information acquiring program 2515 sends, to the external storage device 30, the specific area extracted in step S340 (step S350).

Then, the image processor 23 sends the identification code acquiring request to the external storage device 30 (step S360).

Acquiring the identification code from the external storage device 30, the image processor 23 reads out the image generating program 2517 (step S370).

In the first image, the image processor 23 having read out the image generating program 2517 replaces the image area, which corresponds to the specific area, with the identification code acquired from the external storage device 30, thereby to generate the second image (step S380).

The image processor 23, via the image outputter 21, outputs the second image as the document printout or document data (step S390), and ends the process.

By the way, when determining that the image replacing is not permitted (step S310; No) or the specific area matching the specific condition is not present (step S330; No), the image processor 23 outputs the first image as the document printout or document data via the image outputter 21 (step S400), and ends the process.

1.2.3 Regarding Process of External Storage Device 30

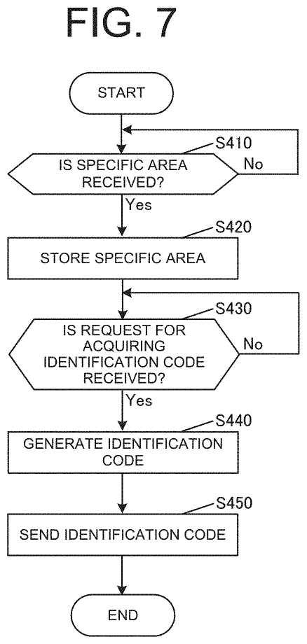

Then, the process of the external storage device 30 will be described using the flowchart in FIG. 7. First, the external storage device 30 determines whether or not the specific area has been received from the multifunction peripheral 10 (step S410).

When determining that the specific area has been received from the multifunction peripheral 10, the controller 31 of the external storage device 30 stores the received specific area in the specific area storing area 395 (step S410; Yes→step S420).

Then, the controller 31 determines whether or not the identification code acquiring request has been received from the multifunction peripheral 10 (step S430).

When determining that the identification code acquiring request has been received from the multifunction peripheral 10, the controller 31 reads out the identification code generating program 393.

The controller 31 having read out the identification code generating program 393 images the access information for accessing the specific area stored in the specific area storing area 395, thereby to generate the identification code (step S440).

Then, the controller 31 sends the generated identification code to the multifunction peripheral 10 (step S450).

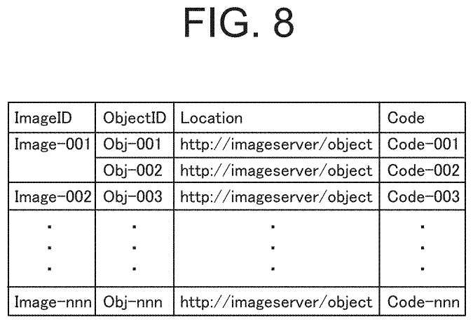

Here, FIG. 8 is a diagram describing an example of a data configuration of an identification code correspondence table showing the relation between the identification code generated by the controller 31 and a specific area (Object) included in the first image.

In FIG. 8, “image ID” is an identification ID to uniquely specify the first image. “Object ID” is an identification ID representing a specific area included in the first image. “Location” is access information (path information) for accessing the specific area (Object) stored in the specific area storing area 395. “Code” is an image of an identification code that images the access information.

In FIG. 8, for example, the first image identified by “image-001” represents that two objects, that is, “Obj-001” and “Obj-002” as the specific areas, are included. Then, “Obj-001” and “Obj-002” sent to the external storage device 30 are stored in the specific area storing area 395 that uses “http://imageserver/object” as access information (path information). The controller 31 of the external storage device 30 generates, as an identification code expressed by “Code-001”, the access information for accessing the “Obj-001” stored in the specific area storing area 395.

1.2.4 Regarding Process of Terminal Device 50

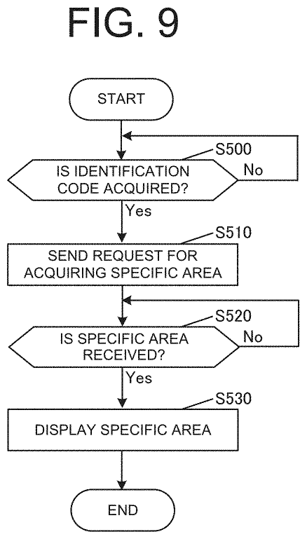

Then, the process of the terminal device 50 will be described using the flowchart in FIG. 9. First, the controller 51 of the terminal device 50 reads out the specific area acquiring program 613.

When the second image is output as the document printout, the controller 51 having read out the specific area acquiring program 613 controls the identification code input 59 thereby to acquire an identification code. In addition, when the second image is output as the document data, the controller 51 can acquire the identification code via the communicator 57 or the like (step S500).

When determining that the identification code has been acquired from the multifunction peripheral 10, the controller 51, based on the access information included in the identification code, sends the specific area acquiring request to the external storage device 30 (step S510).

Then, the controller 51 determines whether or not the specific area has been received (step S520). When determining that the specific area has been acquired, the controller 51 displays the received specific area on the display 53 (step S530), and end the process.

### 1.3 Operation Example

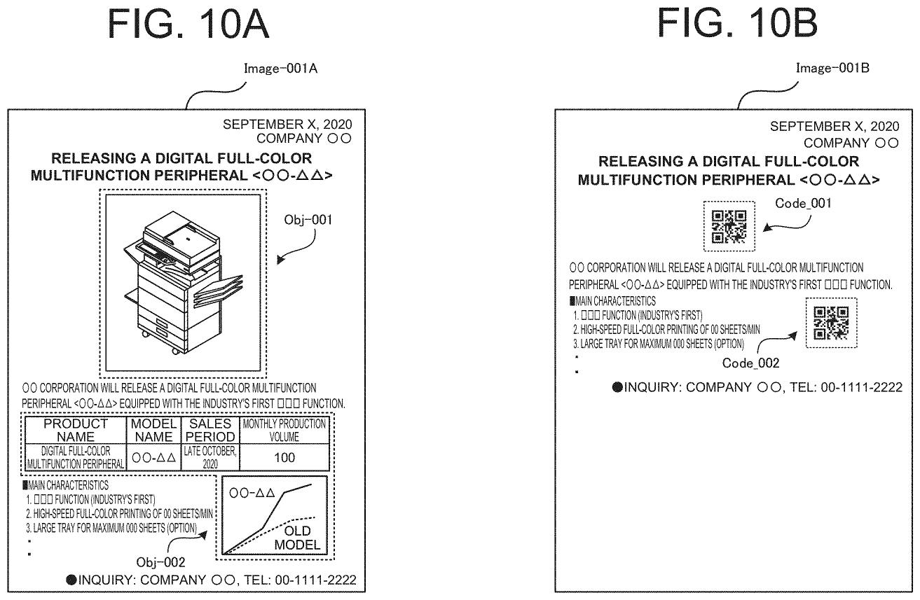

Then, an operation example according to the first embodiment will be described. FIG. 10A schematically illustrates, as Image-001A, a press release related to release of a digital full-color multifunction peripheral <∘∘-ΔΔ>, as the first image. Note that the Image-001A may be a document printout or document data.

In addition to texts such as “RELEASING A DIGITAL FULL-COLOR MULTIFUNCTION PERIPHERAL <∘∘-ΔΔ>”, “∘∘ CORPORATION WILL RELEASE A DIGITAL FULL-COLOR MULTIFUNCTION PERIPHERAL <∘∘-ΔΔ>EQUIPPED WITH THE INDUSTRY'S FIRST □□□ FUNCTION.”, and the like, the Image-001A is formed with Obj-001 that illustrates an image of the digital color multifunction peripheral, and Obj-002 that has a table which summarizes product name, model name, sales period and monthly production volume, and a comparison graph. The present operation example will be described based on an assumption that the Obj-001 and the Obj-002 are the specific areas matching the specific condition, that is, the Obj-001 and the Obj-002 are objects causing a large color material consumption amount in the case of printing out.

From the Image-001A, the image processor 23 having read out the image replacing program 251 extracts the Obj-001 and Obj-002 as the specific areas matching the specific condition. The image processor 23 sends the extracted Obj-001 and Obj-002 to the external storage device 30, and makes the identification code acquiring request. In the Image-001A, the image processor 23 having acquired the identification code from the external storage device 30 replaces the image area, which corresponds to the Obj-001 and the Obj-002, with the identification code acquired from the external storage device 30, thereby to generate the second image.

FIG. 10B is an example of the second image (Image-001B) generated by replacing the image areas, which correspond to the Obj-001 and the Obj-002 in Image-001A, with the identification code acquired from the external storage device 30.

FIG. 10B is an example of replacing the Obj-001 with an identification code Code-001 and replacing the Obj-002 with an identification code Code-002, and then adjusting the overall layout (see FIG. 8).

The identification code to be replaced is converted to a size smaller than the image size of the original object, and the layout of the overall drawing area is adjusted; therefore, while the Image-001B retains the necessary information to be displayed to the user, the overall drawing size can be reduced compared to the Image-001A.

The object to be replaced with the identification code relates to the image area where the color material amount consumed in the case of printing out is larger than the predetermined threshold. Therefore, the color material consumption amount related to the formation of the Image-001B can be reduced.

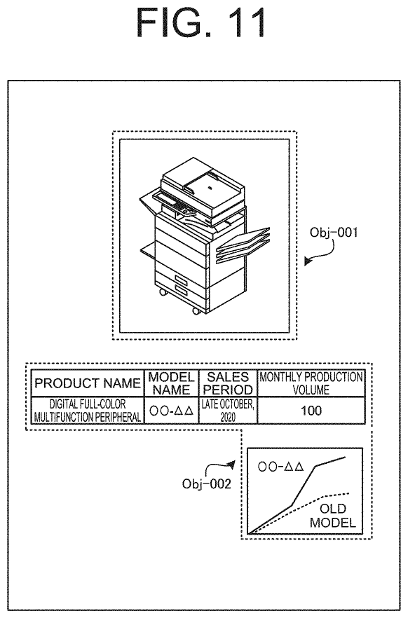

FIG. 11 is an operation image rendered when the Code-001 and Code-002 on the Image-001B exemplified in FIG. 10B are read by the terminal device 50, and the Obj-001 corresponding to the Code-001 and the Obj-002 corresponding to the Code-002 are displayed.

The Code-001 and the Code-002 respectively include access information for accessing the corresponding original objects Obj-001 and Obj-002. The user of the terminal device 50 reads the Code-001 and Code-002 with the terminal device 50 and accesses the external storage device 30, thereby making it possible to acquire the Objects Obj-001 and Obj-002 stored in the specific area storing area 395.

In addition, FIG. 11 is the example of showing only the Obj-001 and Obj-002 acquired from the external storage device 30, but the image shown by the Image-001A may be reconfigured by placing the Obj-001 and Obj-002 respectively in positions showing the Code-001 and Code-002 on the Image 001B.

As described above, according to the first embodiment, the color material consumption amount related to the image formation in the specific area can be reduced, and adjusting the layout after the identification code replacing can also reduce the number of sheets of printing media, thus making it possible to reduce costs.

In addition, since the image of the specific area is sent to and stored in the external storage device 30, a decoder for decoding the coded secret information for each viewer environment is not required for visualization of the coded secret information. In addition, the image related to the specific area is managed in the external storage device 30. Therefore, even if some change should occur in the specific area, the specific area stored in the external storage device 30 can be manipulated. This allows for more flexible management. In addition, since the identification code including the access information for accessing the specific area can be generated by the external storage device 30, there is no risk of diffusing of the information necessary for decoding, making it possible to prevent any unspecified other person from viewing the information.

When the document data is to be rasterized for printing, counting the pixel value seen after the color conversion process of the chart/image area can estimate the color material consumption amount; for the sake of process simplicity, however, it is acceptable to determine, as a specific area, an object with an area equal to or more than a predetermined standard, based on merely the arrangement information (height and width sizes) of the chart/image area.

In addition, of the chart/image, the image area related to a color object may be a target to be replaced with the identification code, or only the color object may be sent to the external storage device 30 while all including the color object are printed in black and white. In this case, the identification code may be given to each color object, or the identification code may be given to each page that includes the color object.

In addition, it is allowed that, for example, as an input image of image search, using a monochrome printed object area without an identification code given acquires the corresponding color object from the external storage device 30 and displays the color object.

### 2. Second Embodiment

In a second embodiment, a case where, at the time of selecting the character size changing mode and as a result of character enlarging, an image area that reduces the number of characters outputtable within a predetermined page is present is defined as the specific condition. When the specific area matching the specific condition is present, sending the specific area to the external storage device 30 can suppress the number of sheets of print media consumed during the printing while improving the readability of the enlarged character.

2.1 Functional Configuration

The functional configuration of the second embodiment can be similar to that of the first embodiment, except that the configuration of a part of the image replacing program stored in the storage of the multifunction peripheral is different. Therefore, in the following description, different functional configuration will be described, and the same functional configuration will be omitted.

2.1.1 Regarding Multifunction Peripheral 70

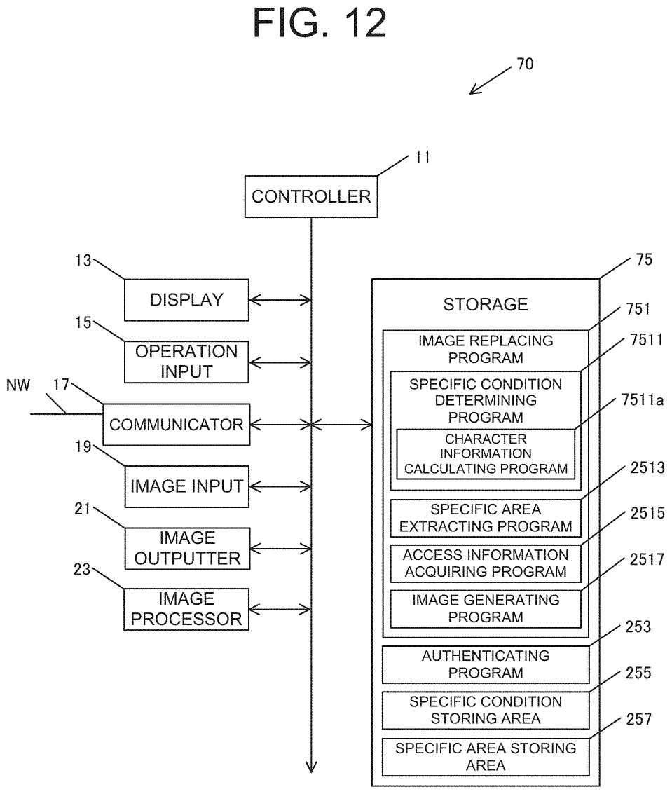

FIG. 12 is a diagram describing the functional configuration of the multifunction peripheral 70. The multifunction peripheral 70 has a storage 75 in place of the storage 25 of the multifunction peripheral 10 according to the first embodiment.

In the second embodiment, the storage 75 stores an image replacing program 751 and the authenticating program 253, and secures the specific condition storing area 255 and the specific area storing area 257.

The image replacing program 751 is read out by the image processor 23 when executing the image replacing process on the input document printout or document data. The image replacing program 751 includes a specific condition determining program 7511, the specific area extracting program 2513, the access information acquiring program 2515, and the image generating program 2517.

The specific condition determining program 7511 is read by the image processor 23 when determining whether or not a specific area matching the specific condition is present in the first image that is included in the document printout or document data. In the second embodiment, an image area where, at the time of printing, copying, scanning, file exporting, data exporting, or the like, the character size changing mode to enlarge a character is selected, and as a result of the character enlarging, the number of outputtable characters is reduced is defined as the specific area. The specific condition including a threshold of the number of outputtable characters is stored in the specific condition storing area 255.

In the present disclosure, the file exporting is intended to output the image information by exporting the image information to a file to be distributed in a conference system or a file to be attached to an e-mail, for example, whereas the data exporting is, without being limited to the file exporting, intended to output the image information on a real time display such as display screen, for example.

A character information calculating program 7511a is read out by the image processor 23 when calculating the number of to-be-enlarged characters and an exclusive area of the character area, which includes the enlarged characters, relative to an outputtable area. The image processor 23 having read out the specific condition determining program 7511 compares the calculated number of enlarged characters with the threshold (as the specific condition read out from the specific condition storing area 255) of the number of characters outputtable within the page, and compares the calculated exclusive area with the threshold (as the specific condition read out from the specific condition storing area 255) of the outputtable area, thereby to determine whether or not a specific area matching the specific condition is present in the first image. In other words, with the first image involving the image area, and when, with the character enlarged, there is an image area that cannot be fit in the outputtable area, the image processor 23 determines this to be the specific area.

Functional configurations of the external storage device 30 and the terminal device 50 can be the same as those in the first embodiment, so the description thereof here is omitted.

2.2 Flow of Processes

The flow of processes of the second embodiment can be executed in a similar manner to the first embodiment. In the second embodiment, “calculate color material amount” process according to step S320 in FIG. 6 is replaced with “calculate the number of characters”.

When determining in step S310 of FIG. 6 that the image replacing is permitted, the image processor 23 reads out the image replacing program 751. Then, the image processor 23 having read out the character information calculating program 7511a calculates the number of to-be-enlarged characters, and the exclusive area of the character area, which includes the enlarged characters, relative to the outputtable area (step S310; Yes→step S320).

The number of to-be-enlarged characters, and the exclusive area can be calculated depending on (1) in the case of printing (2) or in the case of copying/scanning.

For example, (1) in the case of printing, the page description language output from the printer driver includes information such as the starting point of placement, size . . . etc., in addition to attribute information (text/vector/raster) of each area. Using the above pieces of information can specify the area where characters, when enlarged, contact or overlap each other. When a character string folding setting is made for the image area (vector/raster) portion, the area that can be possessed by the character area can be determined according to the setting type. This makes it possible to determine whether or not an image area that cannot fit in the outputtable area when the character is enlarged is present.

(2) When the paper document is read by the image input 19 (scanner), as in the case of copying/scanning, the character can be treated in the same way as in the case of (1) printing. Simply, magnifying the character as it is optically read can specify the area where the characters contact or overlap each other. In addition, reading the character portion (area) with the OCR (Optical character recognition) function can take the same action as the character string folding setting in (1).

### 2.3 Operation Example

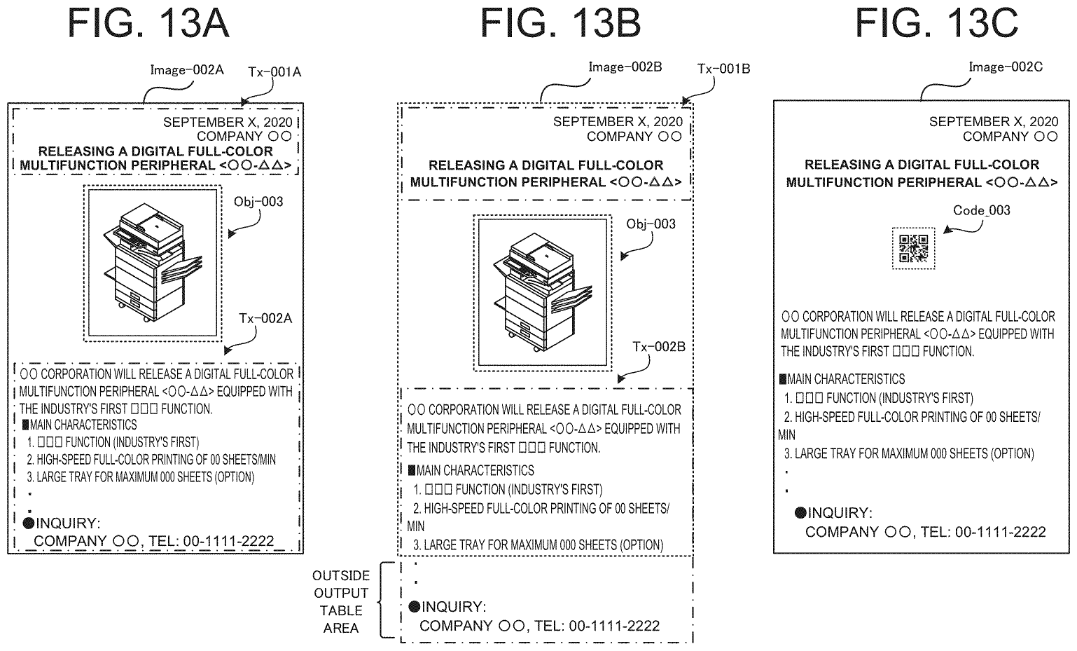

Then, an operation example according to the second embodiment will be described. FIG. 13A schematically illustrates, as Image-002A, the press release related to release of the digital full-color multifunction peripheral <∘∘-ΔΔ>, as the first image. Note that the Image-002A may be the document printout or document data.

In addition to texts such as “RELEASING A DIGITAL FULL-COLOR MULTIFUNCTION PERIPHERAL <∘∘-ΔΔ>” Tx-001A and “∘∘ CORPORATION WILL RELEASE A DIGITAL FULL-COLOR MULTIFUNCTION PERIPHERAL <∘∘-ΔΔ>EQUIPPED WITH THE INDUSTRY'S FIRST □□□ FUNCTION.” Tx-002A, the Image-002A is formed with Obj-003 that illustrates an image of the digital color multifunction peripheral. The present operation example describes an operation example in the case of enlarging the texts that relate to the Tx-001A and the Tx-002A.

When the characters included in the texts (within a single-dot dashed box) related to the Tx-001A and the Tx-002A are enlarged as exemplified by Image-002B in FIG. 13B (in the figure, corresponding to Tx-001B and Tx-002B respectively), the image processor 23 having read out the image replacing program 751 calculates the number of to-be-enlarged characters and an exclusive area of the character area, which includes the enlarged characters, relative to the outputtable area.

Then, as a result of enlarging the texts related to the Tx-001A and the Tx-002A, as shown in FIG. 13B, when the texts that relate to the Tx-002B do not fit in the outputtable area and are located outside the outputtable area, the image processor 23 extracts the Obj-003 as the specific area matching the specific condition.

The image processor 23 sends the extracted Obj-001 to the external storage device 30, and makes the identification code acquiring request. In Image-002C shown in FIG. 13C, the image processor 23 having acquired the identification code from the external storage device 30 replaces the image area, which corresponds to the Obj-003, with an identification code Code-003 acquired from the external storage device 30, thereby to generate the second image. As shown in the Image-002C, replacing the image area, which corresponds to the Obj-003 with the Code-003 reduces the area related to the display of the Obj-003, making it possible to store the displays of the Tx-001B and Tx-002B in the same page.

As described above, according to the second embodiment, since the image of the specific area is sent to and stored in the external storage device 30, a decoder for decoding the coded secret information for each viewer environment is not required for visualization of the coded secret information. In addition, the image related to the specific area is managed in the external storage device 30. Therefore, even if some change should occur in the specific area, the specific area stored in the external storage device 30 can be manipulated. This allows for more flexible management. In addition, since the identification code including the access information for accessing the specific area can be generated by the external storage device 30, there is no risk of diffusing of the information necessary for decoding, making it possible to prevent any unspecified other person from viewing the information.

In addition, according to the second embodiment, the number of sheets of print media consumed during the printing can be suppressed while improving the readability of the enlarged character.

### 3. Third Embodiment

In a third embodiment, a case where an image area having an information amount larger than the information amount required on the drawing medium such as display screen or on the printing medium such as paper sheet is present is defined as the specific condition, and sending, to the external storage device 30, the specific area matching the specific condition can reduce the unnecessary redundant data amount.

3.1 Functional Configuration

The functional configuration of the third embodiment can be similar to that of the first embodiment, except that the configuration of a part of the image replacing program stored in the storage of the multifunction peripheral is different. Therefore, in the following description, different functional configuration will be described, and the same functional configuration will be omitted.

3.1.1 Regarding Multifunction Peripheral 90

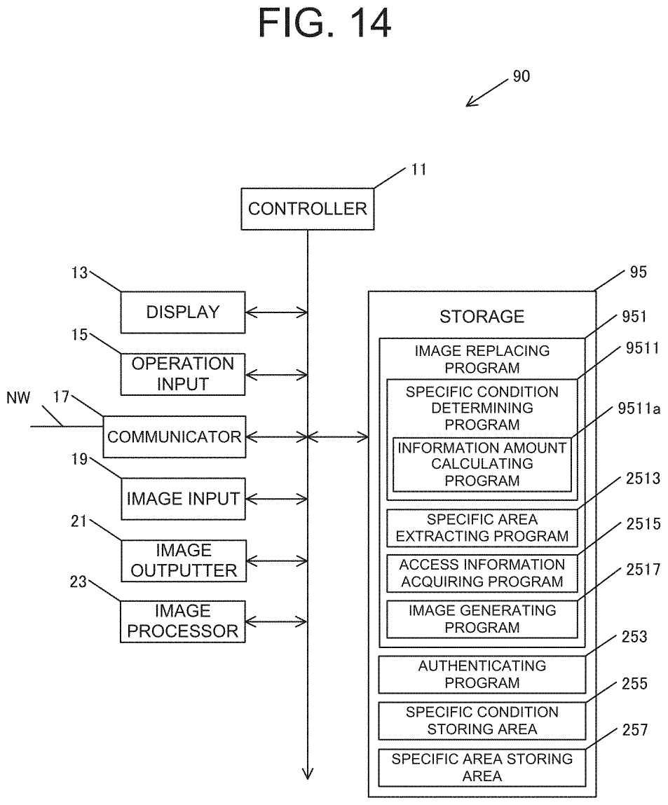

FIG. 14 is a diagram describing the functional configuration of a multifunction peripheral 90. The multifunction peripheral 90 has a storage 95 in place of the storage 25 of the multifunction peripheral 10 according to the first embodiment.

In the third embodiment, the storage 95 stores an image replacing program 951 and the authenticating program 253, and secures the specific condition storing area 255 and the specific area storing area 257.

The image replacing program 951 is read out by the image processor 23 when executing the image replacing process on the input document printout or document data. The image replacing program 951 includes a specific condition determining program 9511, the specific area extracting program 2513, the access information acquiring program 2515, and the image generating program 2517.

The specific condition determining program 9511 is read out by the image processor 23 when determining whether or not the specific area matching the specific condition is present in the first image that is included in the document printout or document data. In the third embodiment, the image area having the information amount larger than the information amount required at the drawing medium or printing medium for printing, copying, scanning, file exporting, data exporting, or the like is defined as the specific area. The specific condition, including a threshold of the information amount required at the drawing medium or printing medium, is stored in the specific condition storing area 255.

An information amount calculating program 9511a is read out by the image processor 23 when calculating the specific area's information amount required at the drawing medium or printing medium. The image processor 23 having read out the specific condition determining program 9511 compares the calculated specific area's information amount with the information amount threshold, etc. as the specific condition read out from the specific condition storing area 255, thereby to determine whether or not the specific area matching the specific condition is present in the first image.

Functional configurations of the external storage device 30 and the terminal device 50 can be the same as those in the first embodiment, so the description thereof here is omitted.

3.2 Flow of Processes

The flow of processes of the third embodiment can be executed in a similar manner to the first embodiment. In the third embodiment, “calculate color material amount” process according to step S320 in FIG. 6 is replaced with “calculate information amount” process.

When determining in step S310 of FIG. 6 that the image replacing is permitted, the image processor 23 reads out the image replacing program 951. Then, the image processor 23 having read out the information amount calculating program 9511a calculates the specific area's information amount required at the drawing medium or printing medium (step S310; Yes→step S320).

3.3 Operation Example

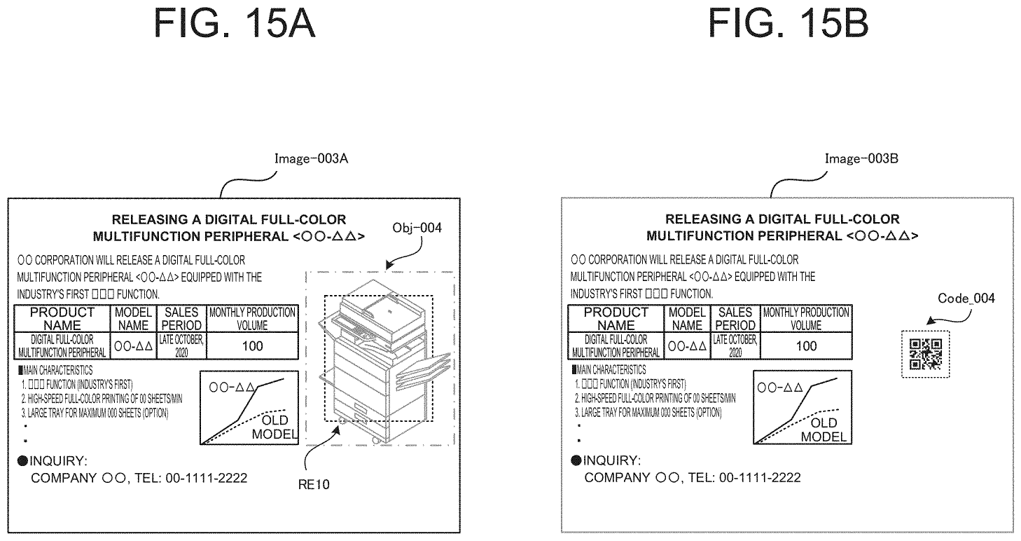

Then, an operation example according to the third embodiment will be described. FIG. 15A schematically illustrates, as Image-003A, a presentation material related to release of the digital full-color multifunction peripheral <∘∘-ΔΔ>, as the first image. Note that the Image-003A may be the document printout or document data.

The present operation example describes the operation example in which the information amount of Obj-004 is larger than the specific area's information amount required at the drawing medium or printing medium. As shown in FIG. 15A, the Image-003A is limited to an image area RE10 where the information amount to display the Obj-004 representing the image of the digital color multifunction printer is indicated by the dotted line box in the figure.

Since the image area of the Obj-004 indicated by the single-dot dashed box in the figure is larger than the image area RE10 indicated by the dotted line in the figure, the image processor 23 having read out the image replacing program 951 extracts the Obj-004 as the specific area matching the specific condition.

The image processor 23 sends the extracted Obj-004 to the external storage device 30, and makes the identification code acquiring request. In Image-003B shown in FIG. 15B, the image processor 23 having acquired the identification code from the external storage device 30 replaces the image area, which corresponds to the Obj-004, with an identification code Code-004 acquired from the external storage device 30, thereby to generate the second image.

As described above, according to the third embodiment, since the image of the specific area is sent to and stored in the external storage device 30, a decoder for decoding the coded secret information for each viewer environment is not required for visualization of the coded secret information. In addition, the image related to the specific area is managed in the external storage device 30. Therefore, even if some change should occur in the specific area, the specific area stored in the external storage device 30 can be manipulated. This allows for more flexible management. In addition, since the identification code including the access information for accessing the specific area can be generated by the external storage device 30, there is no risk of diffusing of the information necessary for decoding, making it possible to prevent any unspecified other person from viewing the information.

In addition, according to the third embodiment, since the image related to the specific area stored in the external storage device 30 should be used only for the enlarged display or high-resolution printing, any redundant data amount unnecessary during the drawing such as presentation or during a normal printing, for example can be reduced. This can smoothen operations such as registering materials to a conference system and attaching to the e-mail.

### 4. Fourth Embodiment

In a fourth embodiment, a case where personal information such as face photograph, name, address, or the like is present in the first image that is included in the document printout or document data is defined as the specific condition, and sending the specific area to the external storage device 30 when the specific area matching the specific condition is present can prevent the personal information from being leaked to any unspecified other person.

4.1 Functional Configuration

The functional configuration of the fourth embodiment can be similar to that of the first embodiment, except that the configuration of a part of the image replacing program stored in the storage of the multifunction peripheral is different. Therefore, in the following description, different functional configuration will be described, and the same functional configuration will be omitted.

4.1.1 Regarding Multifunction Peripheral 110

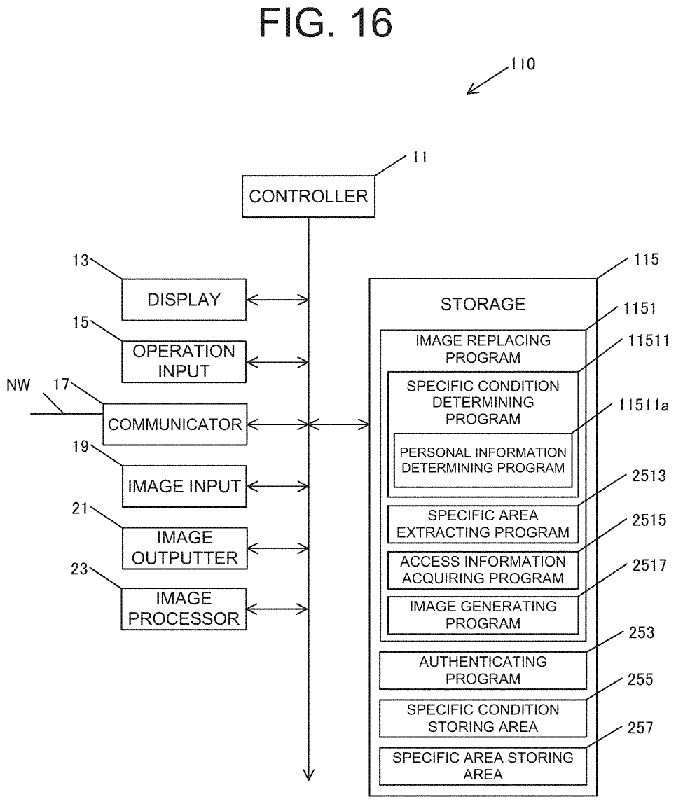

FIG. 16 is a diagram describing the functional configuration of a multifunction peripheral 110. The multifunction peripheral 110 has a storage 115 in place of the storage 25 of the multifunction peripheral 10 according to the first embodiment.

In the fourth embodiment, the storage 115 stores an image replacing program 1151 and the authenticating program 253, and secures the specific condition storing area 255 and the specific area storing area 257.

The image replacing program 1151 is read out by the image processor 23 when executing the image replacing process on the input document printout or document data. The image replacing program 1151 includes a specific condition determining program 11511, a specific area extracting program 2513, the access information acquiring program 2515, and the image generating program 2517.

The specific condition determining program 11511 is read out by the image processor 23 when determining whether or not the specific area matching the specific condition is present in the first image that is included in the document printout or document data. In the fourth embodiment, at the time of printing, copying, scanning, file exporting, data exporting, or the like, a face photograph, and specific keywords such as name, phone number, and address are specified as a personal information-related item, and a character string in the table where the personal information-related item becomes the heading (title) or item name shall be treated as personal information. Then, the image area including the personal information shall be defined as the specific area, and the specific keywords and the like corresponding to the personal information shall be stored in the specific condition storing area 255.

A personal information determining program 11511a is read out by the image processor 23 when determining whether or not the information included in the image area is personal information. The image processor 23 having read out the specific condition determining program 11511 determines whether or not the information included in the image area is the personal information, thereby to determine whether or not the specific area matching the specific condition is present in the first image.

Functional configurations of the external storage device 30 and the terminal device 50 can be the same as those in the first embodiment, so the description thereof here is omitted.

4.2 Flow of Processes

The flow of processes of the fourth embodiment can be executed in a similar manner to the first embodiment. In the fourth embodiment, “calculate color material amount” process according to step S320 in FIG. 6 is replaced with “determine personal information” process.

When determining in step S310 of FIG. 6 that the image replacing is permitted, the image processor 23 reads out the image replacing program 1151. Then, the image processor 23 having read out the personal information determining program 11511a determines whether or not the information included in the image area of the first image is personal information (step S310; Yes→step S320).

### 4.3 Operation Example

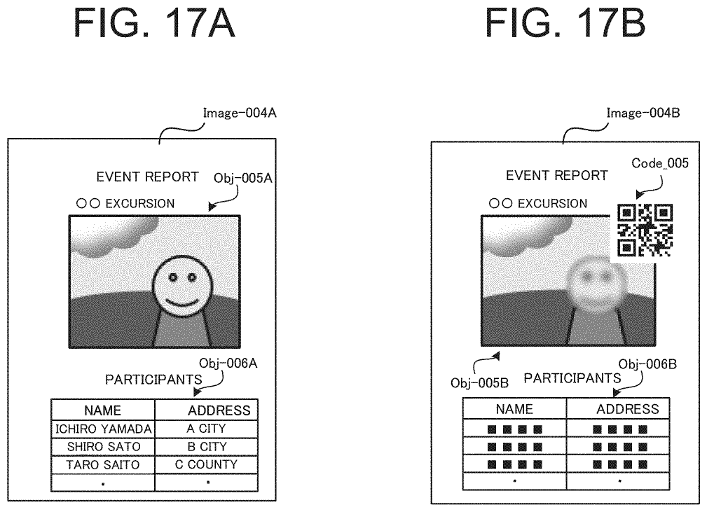

Then, an operation example of the fourth embodiment will be described. FIG. 17A schematically illustrates, as Image-004A, an event report, as the first image. Note that the Image-004A may be the document printout or document data.

In the present operation example, Obj-005A is an example of an object related to a face photograph of a specific individual. In addition, Obj-006A is an example of an object related to the personal information that describes the name and address of the participant who participated in the □□□ excursion. The image processor 23 having read out the image replacing program 1151 determines that these objects match the personal information as a specific condition, and extracts the Obj-005A and Obj-006A as specific areas matching the specific condition.

The image processor 23 sends the extracted Obj-005A and Obj-006A to the external storage device 30, and makes the identification code acquiring request. In Image-004B shown in FIG. 17B, the image processor 23 having acquired the identification code from the external storage device 30 replaces the image area, which corresponds to the Obj-005A, with an identification code Code-005 acquired from the external storage device 30, thereby to generate the second image.

In addition, the object related to the face photograph is replaced with the identification code Code-005, and Obj-005B that has been made by subjecting the above object to a mosaicing, blurring, filling-in, or the like can be further placed.

The Obj-006A is an example of an object that specifies, as the personal information-related item, keywords such as name, telephone number, and address, and treats, as the personal information, the character string in the table where the personal information-related item becomes the heading (title) or item name. In this case, for example, as exemplified in Obj-006B, the character of the relevant item may be replaced with a predetermined hidden character, or the overall character string of the relevant item may be hidden at once. Not causing each item to have the information about access to the external storage device 30, but causing each page to have the information about access to the external storage device 30 is allowed.

In this way, a first condition is defined as the case where the image area includes the personal information other than the face photograph, and a second condition is defined as the case where the image area includes the face photograph; then in the first condition, the personal information is replaced with the image including the identification code, whereas in the second condition, it is possible to replace the face photograph with an image that was subjected to an image processes including at least mosaicing process, blurring process, filling-in process, or the like. In this case, further, the image can be replaced with both an image that has been subjected to the predetermined image process on the face photograph and an image that includes the identification code, as exemplified in FIG. 17B.

As described above, according to the fourth embodiment, since the image of the specific area is sent to and stored in the external storage device 30, a decoder for decoding the coded secret information for each viewer environment is not required for visualization of the coded secret information. In addition, the image related to the specific area is managed in the external storage device 30. Therefore, even if some change should occur in the specific area, the specific area stored in the external storage device 30 can be manipulated. This allows for more flexible management. In addition, since the identification code including the access information for accessing the specific area can be generated by the external storage device 30, there is no risk of diffusing of the information necessary for decoding, making it possible to prevent any unspecified other person from viewing the information.

### 5. Fifth Embodiment

In a fifth embodiment, a case where an image area to which a viewing restriction is given is present in the first image that is included in the document printout or document data is defined as the specific case, and sending the specific area to the external storage device 30 when the specific area matching the specific condition is present restricts the display of the specific area to which viewing restriction is given.

5.1 Functional Configuration

The functional configuration of the fifth embodiment can be similar to that of the first embodiment, except that the configuration of a part of the image replacing program stored in the storage of the multifunction peripheral is different. Therefore, in the following description, different functional configuration will be described, and the same functional configuration will be omitted.

5.1.1 Regarding Multifunction Peripheral 130

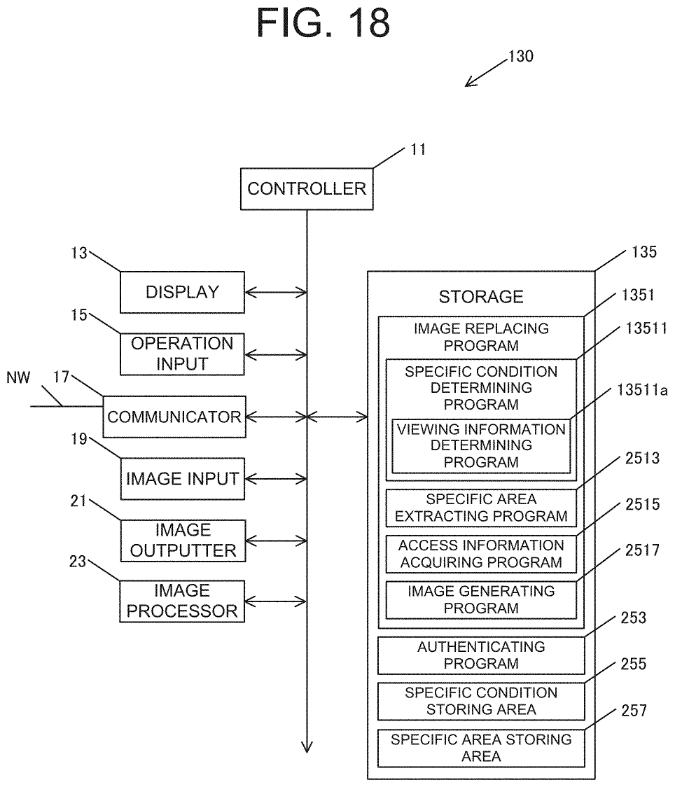

FIG. 18 is a diagram describing the functional configuration of a multifunction peripheral 130. The multifunction peripheral 130 has a storage 135 in place of the storage 25 of the multifunction peripheral 10 according to the first embodiment.

In the fifth embodiment, the storage 135 stores an image replacing program 1351 and the authenticating program 253, and secures the specific condition storing area 255 and the specific area storing area 257.

The image replacing program 1351 is read out by the image processor 23 when executing the image replacing process on the input document printout or document data. The image replacing program 1351 includes a specific condition determining program 13511, the specific area extracting program 2513, the access information acquiring program 2515, and the image generating program 2517.

The specific condition determining program 13511 is read out by the image processor 23 when determining whether or not the specific area matching the specific condition is present in the first image that is included in the document printout or document data. In the fifth embodiment, the specific condition is defined as a case where, at the time of printing, copying, scanning, file exporting, data exporting, or the like, an image area to which the viewing restriction is given is present in the first image, and the image area matching the specific condition is defined as the specific area. For example, keywords such as “SECRET” and “CONFIDENTIAL related to the viewing restriction, and information related to the viewing restriction such as additional information such as attribute tag are stored in the specific condition storing area 255.

A viewing information determining program 13511a is read out by the image processor 23 when determining whether or not the viewing restriction given to the image area included in the first image corresponds to the specific condition. The image processor 23 having read out the specific condition determining program 13511 determines whether or not the viewing restriction included in the first image corresponds to the specific condition, thereby to determine whether or not the specific area matching the specific condition is present in the first image. Since the viewing restriction can be given to each image area included in the first image, the image processor 23 having read out the specific condition determining program 13511 determines whether or not the viewing restriction corresponds to the specific condition for all image areas.

Functional configurations of the external storage device 30 and the terminal device 50 can be the same as those in the first embodiment, so the description thereof here is omitted.

5.2 Flow of Processes

The flow of processes of the fifth embodiment can be executed in a similar manner to the first embodiment. In the fifth embodiment, “calculate color material amount” process according to step S320 of FIG. 6 is replaced with “determine viewing information” process, and “store specific area” process according to step S420 of FIG. 7 is replaced with “store specific area and viewing user” process.

When determining in step S310 of FIG. 6 that the image replacing is permitted, the image processor 23 reads out the image replacing program 1351. Then, the image processor 23 having read out the viewing information determining program 13511a determines whether or not the viewing restriction is given to the image area included in the first image (step S310; Yes→step S320).

In step S420 of FIG. 7, when specifying, in addition to the specific area, the user who is permitted to view the specific area, the controller 31 of the external storage device 30 also stores any user information of the user. The stored user information is converted into an identification code along with the information about access to the specific area. Meanwhile, when not specifying the user who is permitted to view the specific area, the controller 31 converts, into an identification code, permission information permitting the viewing of the specific area, together with the information about access to the specific area (step S440).

### 5.3 Operation Example

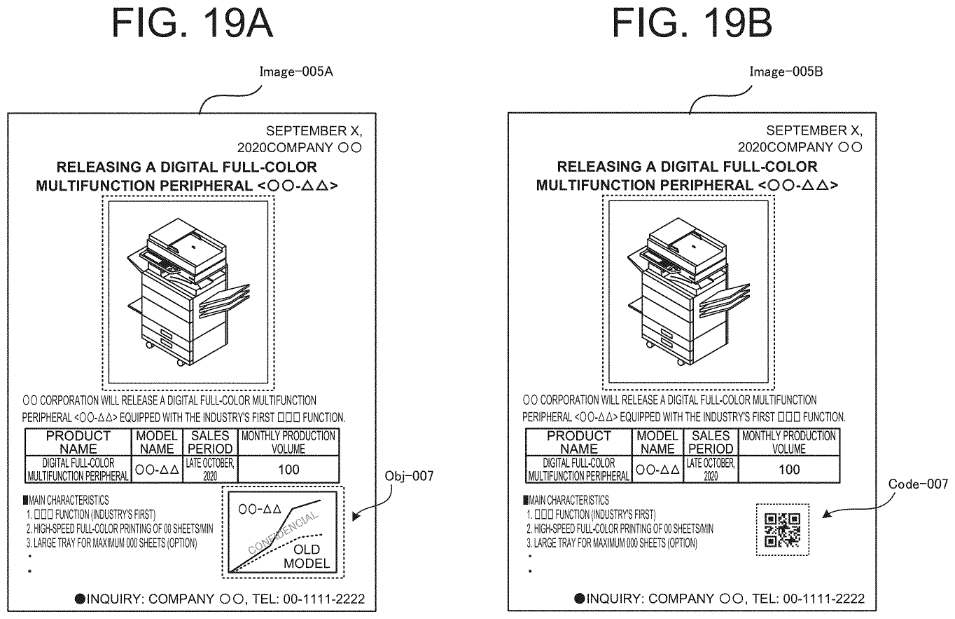

Then, an operation example according to the fifth embodiment will be described. FIG. 19A schematically illustrates, as Image-005A, the press release related to release of the digital full-color multifunction peripheral <∘∘-ΔΔ>, as the first image. Note that the Image-005 A may be the document printout or document data.

In the present operation example, Obj-007 is an example of an object to which a keyword “CONFIDENTIAL” related to the viewing restriction is given. The image processor 23 having read out the image replacing program 1351 determines that the above object matches the viewing restriction as the specific condition, and extracts the Obj-007 as a specific area matching the specific condition.

The image processor 23 sends the extracted Obj-007 to the external storage device 30, and makes the identification code acquiring request. In Image-005B shown in FIG. 19B, the image processor 23 having acquired the identification code from the external storage device 30 replaces the image area, which corresponds to the Obj-007, with an identification code Code-007 acquired from the external storage device 30, thereby to generate the second image.

As described above, according to the fifth embodiment, since the image of the specific area is sent to and stored in the external storage device 30, a decoder for decoding the coded secret information for each viewer environment is not required for visualization of the coded secret information. In addition, the image related to the specific area is managed in the external storage device 30. Therefore, even if some change should occur in the specific area, the specific area stored in the external storage device 30 can be manipulated. This allows for more flexible management. In addition, since the identification code including the access information for accessing the specific area can be generated by the external storage device 30, there is no risk of diffusing of the information necessary for decoding, making it possible to prevent any unspecified other person from viewing the specific area's image for which viewing is not permitted.

The present disclosure is not limited to the above embodiments, but can be modified in various manners. That is, any embodiment acquired by combining any technical means modified as appropriate within the scope that does not depart from the gist of the present disclosure is also included in the technical scope of the present disclosure.

Although some of the above embodiments are described separately for convenience of description, it is of course possible to combine them to the extent technically feasible.

In addition, the program that operates in each device in the embodiment controls a CPU and the like (makes a computer function) so as to realize the functions of the above embodiments. And, the information treated by these devices is temporarily stored in a temporary storage (e.g., RAM) at the time of processing the information, then is stored in various ROMs (Read Only Memory), HDDs or other storages, and, if necessary, is read out, modified, and written by the CPU.

Herein, recording media for storing the program may be any of semiconductor media (e.g., ROMs, and nonvolatile memory cards), optical and magneto-optical recording media (e.g., DVD (Digital Versatile Disc), MO (Magneto Optical Disc), MD (Mini Disc), CD (Compact Disc), and BD (Blu-ray (registered trademark) Disk), and magnetic recording media (e.g., magnetic tape, and flexible disk). Not only is the function of the above embodiments realized by executing the loaded program, but also the function of one aspect of the present disclosure is, as the case may be, realized by processing jointly with the operating system or any other application programs, based on an instruction of that program.

When distributed in the market, the program can be stored in a portable recording medium, or can be transferred to a server computer connected via a network such as the Internet. In this case, the storage of the server computer is of course included in the present disclosure.

What is claimed is:

1. An image output device, comprising:
a controller; and
an image outputter, wherein
the controller, when a specific area that matches a specific condition is present in a first image, stores, in a storing area, information that is based on the specific area,
generates an identification code that includes access information for accessing the stored information that is based on the specific area, and
outputs a second image where the specific area of the first image is replaced with an image that includes the identification code.

2. The image output device according to claim 1, wherein
the controller estimates a color material amount used when outputting the image, and
the specific area is an area where the color material amount exceeds a predetermined amount.

3. The image output device according to claim 1, wherein
the controller determines a character size used when outputting the image, and
the specific area is an area where the number of outputtable characters is reduced when the character size is changed.

4. The image output device according to claim 1, wherein
the controller calculates an information amount to be output, and
the specific area is an area where the information amount that can be output exceeds the information amount that is required.

5. The image output device according to claim 1, wherein the specific area is an image area that includes personal information.

6. The image output device according to claim 1, wherein
the controller can set a viewing restriction for each area, and
the specific area is an area where the viewing restriction is set.

7. The image output device according to claim 6, wherein the controller specifies a user to whom the viewing restriction applies, and stores the specified user's information in the storing area.

8. The image output device according to claim 6, wherein the controller, when not specifying a user to whom the viewing restriction applies, generates permission information to permit a viewing of the specific area.

9. The image output device according to claim 1, wherein the identification code is a bar code and/or a two-dimensional code.

10. The image output device according to claim 1, wherein
the controller,
with the specific condition being a first condition, replaces the specific area with an image that includes the identification code, and,
with the specific condition being a second condition, replaces the specific area with an image that was subjected to an image process including at least a mosaicing process, a blurring process, or a filling-in process.

11. The image output device according to claim 10, wherein
the controller, with the specific condition being the second condition, replaces the specific area with the image that was subjected to the image process and the image that includes the identification code.

12. The image output device according to claim 1, wherein the storing area is an image forming device or a storage device that can be connected via a network.

13. The image output device according to claim 1, wherein the access information includes a URL (Uniform Resource Locator), a host name, or an IP (Internet Protocol) address.

14. An image output system, comprising:
an image output device having a controller and an image outputter; and
a storage device having a storage and an outputter, wherein
the controller, when a specific area that matches a specific condition is present in a first image, has the storage store information that is based on the specific area,
generates an identification code that includes access information for accessing the stored information that is based on the specific area, and
outputs a second image where the specific area of the first image is replaced with an image that includes the identification code, and wherein
the outputter, according to an access that is based on the identification code, outputs the image included in the stored specific area.

15. An image outputting method, comprising:
when a specific area that matches a specific condition is present in a first image, storing, in a storing area, information that is based on the specific area;
generating an identification code that includes access information for accessing the stored information that is based on the specific area; and
outputting a second image where the specific area of the first image is replaced with an image that includes the identification code.
